(19) United States
(12) Patent Application Publication
(10) Pub. No.: US 2003/0069750 A1
(43) Pub. Date: Apr. 10, 2003

(54) System for automatic device registration

(75) Inventors: Brian M. Siegel, Washingtonville, NY (US); Philip M. Abram, Warwick, NY (US); Marc Beckwitt, San Anselmo, CA (US); Kazuaki Iso, Oradell, NJ (US); Brian Raymond, San Diego, CA (US); Gregory D. Gudorf, San Diego, CA (US)

Correspondence Address: LERNER, DAVID, LITTENBERG,, KRUMHOLZ & MENTLIK, 600 SOUTH AVENUE WEST, WESTFIELD, NJ, 07090, US

(73) Assignee: Sony Corporation, Tokyo (JP)

(21) Appl. No.: 10/298,490

(22) Filed: Nov. 18, 2002

Related U.S. Application Data
(62) Division of application No. 09/636,665, filed on Aug. 11, 2000.

(51) Int. Cl. G06F 17/60

(52) U.S. Cl. 705/1

(57) ABSTRACT

A system, apparatus and method for automatically registering a product with a registration service. The system generally includes a registration service accessible from a communications network and a product having a communications apparatus for transmitting product and purchaser identifying information to the registration service. When the product is activated, or at another predetermined time or event, the communications apparatus automatically registers the product with the registration service.

### CROSS-REFERENCE TO RELATED APPLICATION

The present application is a division of U.S. patent application Ser. No. 09/636,665, filed Aug. 11, 2000, the disclosure of which is incorporated herein by reference in its entirety.

### FIELD OF THE INVENTION

The present invention relates to automated warranty and purchase registration of consumer products.

### BACKGROUND OF THE INVENTION

The warranty and purchase registration of consumer products, such as, audio/visual (A/V) equipment, stoves, microwaves, refrigerators, washers and dryers, is most often left to the consumer's willingness to complete and mail to the manufacture's registration service a warranty/purchase registration which is enclosed with the product. Many consumers, however, do not complete the supplied warranty/purchase registration, and, as a result, are deprived of potentially valuable post-sale benefits, including product warranties, product updates, promotions, and discounts on future purchases. Under these circumstances, the manufacturer or retailer is also deprived of valuable purchaser information, including purchaser demographic information and other information which assists the manufacture or retailer in handling product returns and issuing refunds.

For computer products, warranty and purchase registration systems have been facilitated by a computer-assisted process that reduces the consumer's involvement. Upon installation of the computer or computer related product, e.g., loading the software into the operating environment of the computer, the consumer is immediately introduced to a set of instructions and screen prompts that enables the customer to register the product by sending information to the registration service over the Internet. See, e.g., U.S. Pat. No. 5,825,983. However, for most consumer products, computer-assisted registration is not feasible, as many consumer products are not connected to a computer or the Internet. Moreover, the computer-assisted registration process still requires some consumer involvement in that most of the information required to complete the registration process must still be supplied by the consumer. Accordingly, there is a need for an improved system and method for registering consumer products. More particularly, there is a need for a system and method for registering consumer products independent of consumer involvement.

### SUMMARY OF THE INVENTION

One aspect of the present invention relates to a system and method for automated consumer product warranty and purchase registration and the like. The system generally includes a registration service accessible from a communications network and a product having a communications unit containing a combination of components for automatically transmitting product and purchase identifying information to a registration service over the communications network. In a preferred embodiment, the communications network is a wireless communications network, such as a paging network, equipped with transmitters and antennas for transmitting radio frequency (RF) signals from the product's communications unit to the registration service. The product's communications unit generally includes a control unit, a memory unit, a transmitter and an antenna which cooperate to transmit information programmed into the memory unit to the registration service at a predetermined time or after a predetermined event or series of events.

In a preferred embodiment of this aspect of the present invention, the registration process is completed entirely independently of the consumer. For example, at the time the product is removed from its packaging and activated for the first time, such as by plugging the consumer product into an outlet, the communications unit automatically transmits a signal encoding product and purchase identifying information to the registration service. The registration service completes the registration using the transmitted information.

In yet another preferred embodiment of this aspect of the present invention, the communications unit transmits information to the registration service at a predetermined time over the lifecycle of the product to inform the registration service of the status of the product. For example, after a predetermined number of hours of use or at a predetermined date, or at the request of the registration service, the communications unit automatically transmits a signal to the registration service registering the product and notifying the registration service of its status, for example, that it is active and in use. The registration service can thereby collect information on a periodic basis, such as, for example, information about the number of products currently in use.

The completion of purchase and warranty registrations and the like are preferably based on the information which is programmed into the communications unit by the manufacturer or distributor of the product. However, in other preferred embodiments of the present invention, the information programmed into the communications unit and transmitted to the registration service is supplemented and/or modified, automatically or at the user's discretion. For example, the geographic location of the product, and in particular, the street address of the user's household, may be determined automatically using components which rely on radio frequency signals received from global positioning satellites to ascertain the street address of the user's household. Additional information may also be obtained from external sources in the user's household and transmitted to the registration service. For example, information may be automatically obtained from devices in a network of audio/visual equipment, which are connected to the product via a BUS or from other household devices in communication with the product. Optionally, additional information may be obtained from the user, wherein the user inputs information, for example, through a remote device, such as the remote control used to operate the product. This additional information along with the product and purchase identifying information preprogrammed into the product is then transmitted to the registration service, automatically or at the user's discretion.

In another aspect of the present invention, a system and method includes monitoring the operation and use of the product and transmitting information relating to the operation and use of the product to the registration service. For example, in a preferred embodiment, the communications unit, automatically or at the user's discretion, monitors and transmits information relating to the number of hours of use of the product, which may then be used by the registration service, for example, to notify consumers about routine maintenance of the product. In yet another preferred embodiment, the communications unit includes a sensor or sensors that monitor a single parameter or a plurality of parameters relating to the operation and use of the product, including wear and failure of product components. Preferably, the sensors transmit signals to a processor located in the control unit of the communications unit. The processor then generates a code related to the specific wear or operational problem detected. The code is then transmitted to the registration service with the pre-selected product and purchase identifying information. The code can be used by the registration service in issuing refunds and authorizing repairs pursuant to a product warranty. Alternatively, the code may be used by the registration service to notify the purchaser of wear or operational problems associated with the code and the need to repair the product.

In yet another preferred embodiment, the communications unit automatically, or at the user's request, monitors and transmits information relating to the interaction of the product with other components, for example, components connected to each other in a network of audio/visual equipment in the user's household. The communications unit may thus serve as a device for monitoring operability and optimizing the product or a network of product components, for example, a home A/V system. The registration service can then communicate with the purchaser regarding the use and set up of the product.

In yet another aspect of the present invention, the system and method includes a communications unit which can receive and display information sent by the registration service. For example, notifications about routine maintenance of the product may be sent by the registration service to the user and displayed, for example, at a user access site connected directly to the product, for example, a liquid-crystal display, or at a user access site, such as a television set linked to the product in a network of audio/visual components. Information transmitted from the registration service may also be directed specifically to the operation of the product. For example, if the product operates on a software system or similar operating system, updates to the software or operating system may be preformed remotely from the registration service by transmitting data to the communications unit to supplement or modify the operating system.

So that the matter in which the above-recited aspects of the invention are attained and can be understood in detail, more particular descriptions of the invention are made by references to certain embodiments of the invention, examples of which are illustrated in the accompanying drawings. While the invention will be described in references to the preferred embodiments, it will be appreciated that the preferred embodiments are not intended to limit the invention to these embodiments and that various substitutions and modifications may be made to the invention disclosed herein without departing from the scope and spirit of the invention. As will be appreciated by one skilled in the art, various combinations for implementing the logical and physical embodiments described herein are possible.

### BRIEF DESCRIPTION OF THE DRAWINGS

FIG. 1 shows a diagram of a communications unit in accordance with one embodiment of the present invention.

FIG. 2 shows a diagram of a communications unit in accordance with one embodiment of the present invention.

FIG. 3 shows a diagram of a communications unit in accordance with one embodiment of the present invention.

FIG. 4 shows a diagram of a communications unit in accordance with one embodiment of the present invention.

FIG. 5 illustrates an example of a procedure for supplementing the preprogrammed information for transmission in the registration service.

FIG. 6 shows a diagram of a communications unit in accordance with one embodiment of the invention.

FIG. 7 shows a diagram of a communications unit in accordance with one embodiment of the invention.

### DETAILED DESCRIPTION OF THE INVENTION

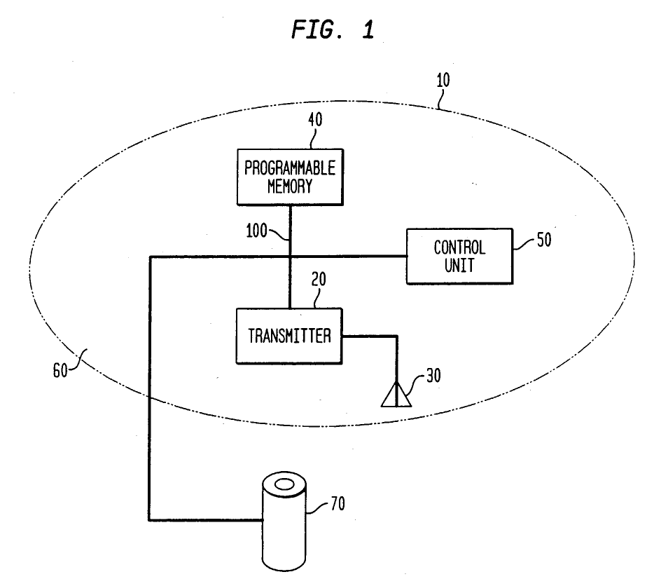

A system and method for automated product warranty/purchase registration of consumer products with a registration service (RS) in accordance with preferred embodiments of the invention are shown in FIGS. 1 through 7. The system generally includes a registration service accessible from a communications network and a consumer product having a communications unit capable of transmitting information to the registration service over the communications network.

Referring to FIG. 1, the communications unit, generally designated as numeral 10, comprises an arrangement of system components, preferably connected in conventional fashion (100), for transmitting information to the registration service. The basic components of the communications unit include a control unit 50, such as a microprocessor, that directs the transmission of information to the registration service at a predetermined time, a transmitter 20 (such as, for example, a radio frequency transmitter), an antenna 30, and a memory unit 40, such as a ROM, a PROM, or an EEPROM, that is programmable by the manufacture to store static product or purchase identifying information. The components are preferably mounted on a substrate 60, which is embedded in, or attached to, the product at a preferred location, for example, by bonding, molding, mechanical attachment (e.g., screws, rivets, etc.) or, if the product is electrical, by integrating the components into the product's circuit.

The communications unit is connected to power source 70 for delivering electrical power to the control unit 50, transmitter 20, memory unit 40, etc. Preferably, power source 70 is the power source used to operate the product. However, if the product is not an electronic component, an independent, activatable power source, such as a battery or a connection to a wall outlet, is required for supplying electrical power to the communications unit.

The control unit may be designed with as much or as little intelligence as the desired application requires. For example, the control unit may automatically direct the transmission of information stored in the memory unit when a sensor detects that the product has been activated. Alternatively, the control unit may be designed to transmit information to the registration service after a predetermined event or plurality of events, for example, after a predetermined number of product uses, or, as discussed below, after the communications unit performs a number of additional tasks (e.g., obtaining additional information for other sources).

In a preferred method of operation, at the time of first activation of the product, for example, when the user removes the product from the packaging and plugs the product into the wall outlet, the control unit receives a signal indicating that the device is on. The control unit then directs the transmission of information stored in the memory unit via the transmitter and antenna to the registration service over the communications network.

In yet another preferred system and method of operation, the communications unit is programmed (such as with an internal clock) to transmit information to the registration service at a predetermined time over the lifecycle of the product to inform the registration service of the status of the product, for example, that the product is in use. For example, after a predetermined number of hours of use (such as every 500 hours of operation) or at a predetermined date (such as January 1 of every year), the communications unit automatically transmits a signal to the registration service notifying the registration service of its status. Alternatively, the registration service can poll one or more products, for example, by sending a signal to all products of a certain brand and model requesting a response, such as a reply transmission or acknowledgement that the product is active. The registration service can thereby collect information on a periodic basis from all products of a specific brand and model, such as, the number of products of a specific brand and model in use at a certain date, etc. In a more preferred embodiment of this aspect of the invention, products of a specific brand and model transmit information over the same communications frequency or share the same base pager account.

In a preferred embodiment, the communications network is a wireless communications network, such as a network of ground stations or orbiting satellites equipped with transmitters and antennas for transmitting radio frequency (RF) signals from the product's communications unit to the registration service. In this regard, a relatively low power transmitter may be used in the communications, for example, as described in U.S. Pat. No. 6,088,593. However, it will be appreciated to one skilled in the art that other communications networks may be employed, including, for example, the internet or a cable network, by connecting the communications unit to telephone lines and cable lines, respectively, in accordance with methods known in the art. If the communications network is the Internet, the transmitter and antenna may be replaced by or also include, a modem or data line connected to a telephone line, either directly or indirectly, such as, for example, through a television set connected to the internet.

The information stored in the memory unit 40 includes any information selected for use in completing warranty/purchase registrations and the like. Preferably, the information stored in the memory unit includes product and purchase identifying codes, such as the brand and model number of the product. More preferably, the information stored in the memory unit includes the universal product code (UPC) and the manufacturer identification number (MIN). Other information programmed into the memory unit may include information (or codes) relating to warranties, rebates or special offers associated with the purchase or product. The memory unit may also store instructions for operating the control unit and performing the tasks of the communications unit, as described herein.

The communications unit may also include system components for supplementing the preprogrammed information. Accordingly, in a preferred embodiment, the communication unit determines the geographic location of the product following activation, and more particularly, the user's property address. The geographic location may be determined using radio frequency (RF) signals transmitted from a constellation of radio-navigation satellites. Apparatus and methods are known for determining the location of an object using radio frequency (RF) signals transmitted from a constellation of radio-navigation satellites, as described, for example, in U.S. Pat. Nos. 6,085,090, 5,839,088 and 5,777,580.

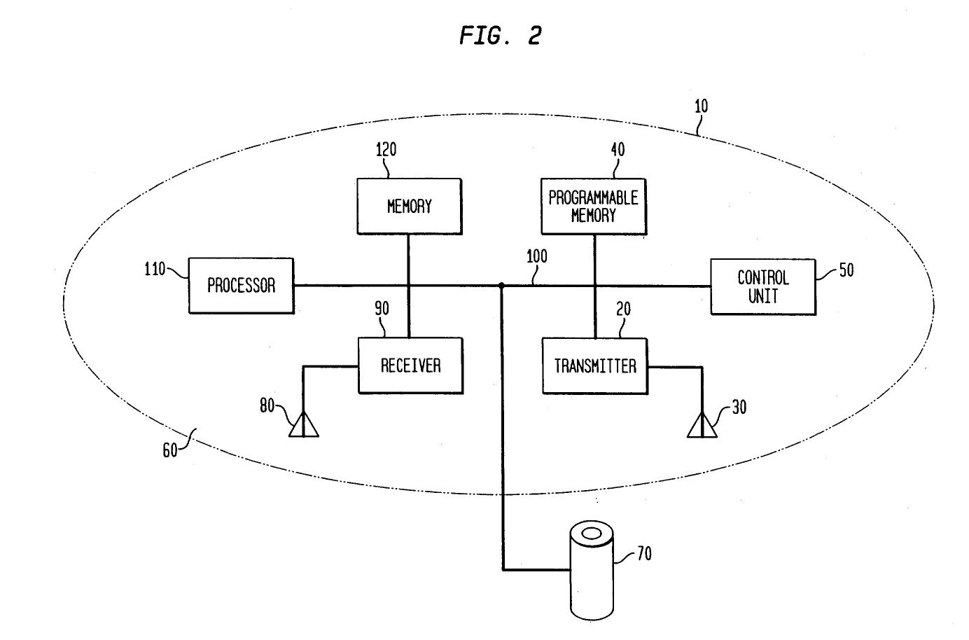

Referring to FIG. 2, in a preferred embodiment, the geo positioning components generally include an antenna 80, a receiver 90, a processor 110 and a memory unit 120 (e.g., a volatile memory such as a random access memory) for receiving, processing and storing radio frequency signals transmitted by global positioning satellites. In the alternative, memory unit 120 can be a non-volatile memory such as an EEPROM. The memory unit 120 stores the geo positioning information received from the global positioning satellites by receiver 90 and antenna 80. The control unit 50 then directs the transmission of the geo positioning information stored in memory unit 120 along with the preprogrammed information stored in memory unit 40 (the programmable memory unit) to the registration service.

Although the geo positioning components have generally been referred to as separate and distinct from the basic components used to transmit information to the registration service, it will be readily appreciated by one skilled in the art that more efficient physical arrangements may be created, by combining, or in some cases, eliminating components. For example, a receiver and transmitter may be combined as transceiver and a common antenna or set of antenna may be used for both transmitting and receiving signals. A control unit and processing unit may also be combined as a central processing unit that directs all tasks of the communications unit.

Additional information may also be supplied to the registration service using information collected from other components in the consumer's household. Accordingly, in another preferred embodiment, upon activation of the product, for example, by connecting the product to a network of A/V components and a power source, the control unit automatically searches the network of A/V components for identifiable devices. Once an identifiable device is found, the existence of the device and potentially other more detailed information stored in the device is collected and transmitted to the registration service along with the product or purchase identifying information preprogrammed into the non-volatile memory unit.

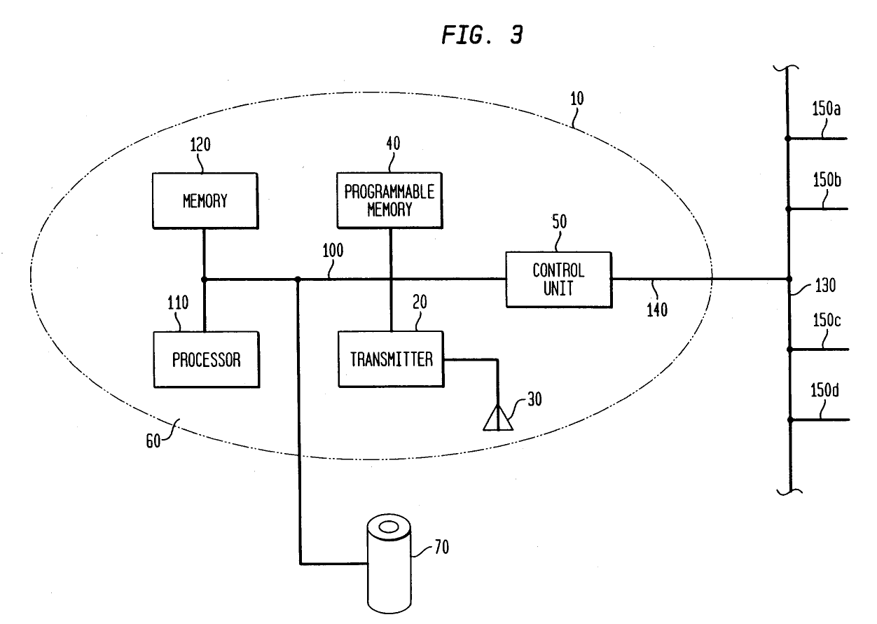

As shown in FIG. 3, in an example of an implementation of the method of obtaining information for other products in a network of A/V components, the communications unit 10 includes a connection to the BUS 130 or other product communications system from which information is exchanged between products in the network of A/V components (150 a, b, c, and d) . The connection is preferably made to BUS 130 via the products input/output control (IOC) (not shown). The communications unit further includes a processor 110 coupled to BUS 130 (e.g., via the IOC), and a memory unit 120, (e.g., a random access memory (RAM)) coupled to the processor 110 for storing information received from other components in the network (150 a, b, c, and d).

In operation, when the product is connected to the network of components, the communications unit initially queries other components in the network to determine whether each component contains additional information or to determine the characteristics of each component in the network of components. If additional information is stored in the component, the information is collected, stored in a memory unit, and transmitted to the registration service with other product and purchase identifying information, as previously described.

Again, although the components used in this preferred embodiment have generally been referred to as separate from the basic components of the communications unit initially described, it will be readily appreciated by one skilled in the art that more efficient physical arrangements may be created, by combining, or in some cases, eliminating components.

Additional information may also be supplied to the registration service by the user. For example, additional information may be input by the user by way of a remote access device. As used herein, the term “remote access device” includes any product control unit, such as an infrared remote control or a keyboard, operatively connected to the communications unit or product in general. Preferably, the information is input using a remote access device which is used to operate the product, for example, a remote control for TV or other A/V equipment or a universal remote used to operate a network of A/V components. However, if the product does not operate with a remote control, the communications unit preferably receives information input from a remote access device used to operate other components in the network of A/V equipment that are in communication with the product. The input information may be viewed through a component connected to the product which has viewing capabilities, such as a TV set, or from an independent user interface, such as a liquid-crystal display, connected to the product.

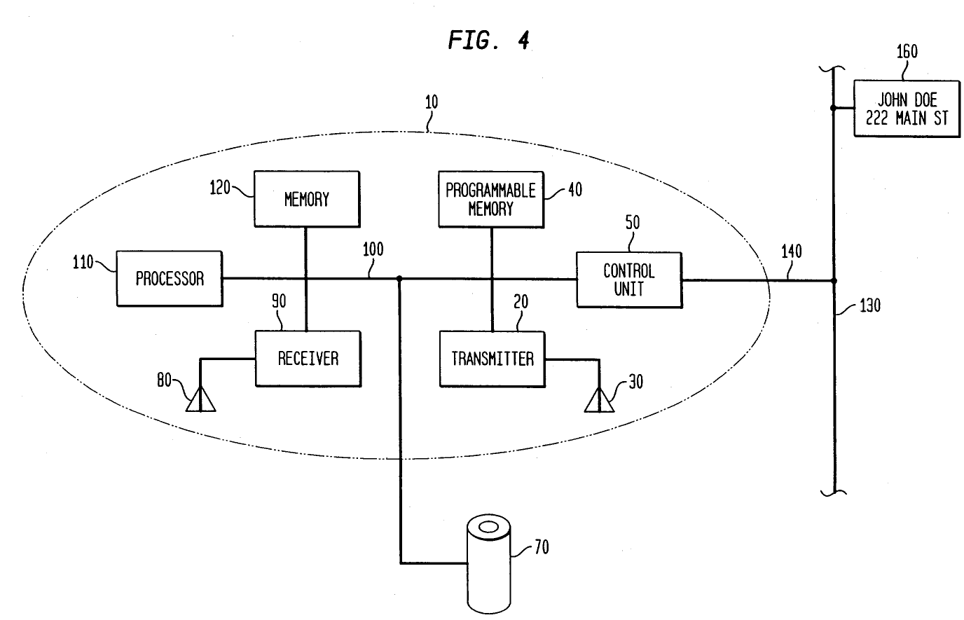

As shown in FIG. 4, in a more preferred embodiment, the communications unit 10 includes a memory unit 120, such as a RAM, for storing information input by the user from a remote access device, a receiver 90, an antenna 80 and a processor 110. In operation, receiver 90 receives the information from the remote access device, either directly or via another component in a network of A/V components in communication with each other as previously described. The receiver stores the information in memory unit 120. The information may be displayed at user access site 160, such as a liquid crystal display or screen. Once the information has been input, the control unit 50, automatically or at the user's command, transmits the information input by the user with the additional information preprogrammed into memory unit 40 to the registration service.

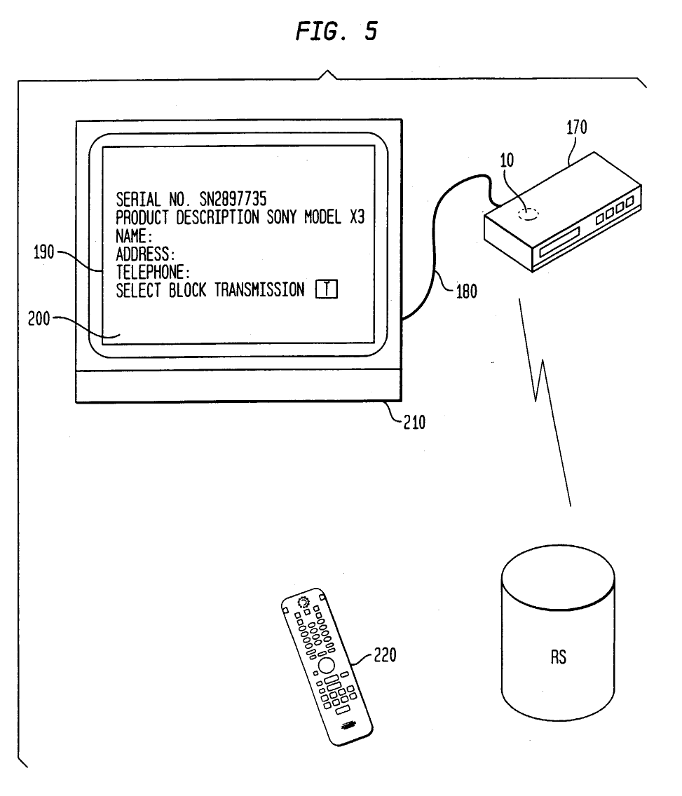

In a more preferred embodiment, as shown in FIG. 5, the product is a component of a home A/V system. When the product is connected to the network of A/V components 180, a screen 190 depicting a registration form 200 is displayed at a user access site 210, such as a television set. The registration screen preferably displays both preprogrammed information (such as, for example, the UPC and MIN codes) as well as spaces where information (such as, for example, a purchaser's name, address, telephone number, e-mail address, etc.) is requested to be input by the user. Using the remote control 220 (e.g., the remote used to operate a television), the user is able to input information or modify information contained in the registration form. Once the information has been entered, the communications unit automatically or at the user's command transmits the information to the registration service along with other purchase or product identifying information stored in memory unit 40.

Other information may also be displayed on the screen or on another screen of options, including, for example, warranty and product information. The displayed registration screen may also contain an option for blocking the transmission of the information to the registration service. When this option is selected by the user, a signal is transmitted to the communication unit instructing the unit to deactivate and to not transmit information to the registration service. Additionally, the user is preferably able to access other files, menus or screens containing information stored in memory unit 40.

The communications unit can also preferably receive signals encoding information sent by the registration service, etc. over the communications network, including, for example, promotional information, warranty information, product maintenance notifications and operational information. The registration service may transmit information using systems and methods know in the art for transmitting signals encoding information from a central station to a remote pager over a communications network.

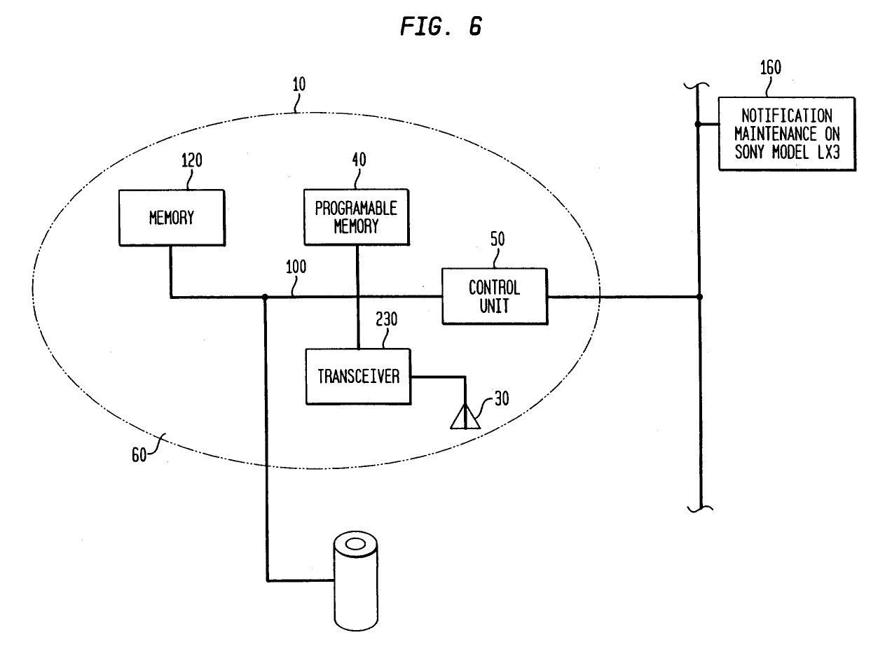

Referring to FIG. 6, the communications unit 10 includes a transceiver 230, antenna 30, control unit 50, a volatile memory unit 120, such as a RAM, and a user access terminal 160, such as a liquid-crystal display or video screen that is part of the product or in communications with the product in a network of components. The user access terminal displays information transmitted from the registration service, etc. over the communications network to the product. As previously described, information may by input and transmitted back to the registration service, using for example, a remote control operatively connected to the communications unit. Again, it should be understood that for this embodiment as well as other embodiments described, although the components have been referred to logically as separate from the basic components of the communications unit initially described, more efficient physical arrangements may be created by combining or eliminating components.

In another aspect of the present invention, the communications unit includes system components for monitoring and transmitting data relating to the operation and use of the product to the registration service. In a preferred embodiment, the communications system monitors the number of hours the product is used, and, automatically or at the user's discretion, transmits the information to the registration service. For example, in the case of a television or radio, apparatus and methods for monitoring the operation of these products are described in U.S. Pat. Nos. 3,919,479; 4,230,990; 4,547,804; 4,639,779; 4,677,466; 4,739,398; 4,805,020; 4,931,871; 4,945,412; 4,967,273 and 5,526,427. The information is then transmitted to the registration service, where, for example, the information may be used to apply warranties, as needed. Additionally, the registration service can use the information to notify the user about routine maintenance on the product after the product has been used for a predetermined number of hours. The notification may be sent directly to the product and displayed at a user access terminal, as previously described, mailed to the user using the street addressed supplied by the communications unit, also as previously described, e-mailed to the user, or supplied in a telephone message.

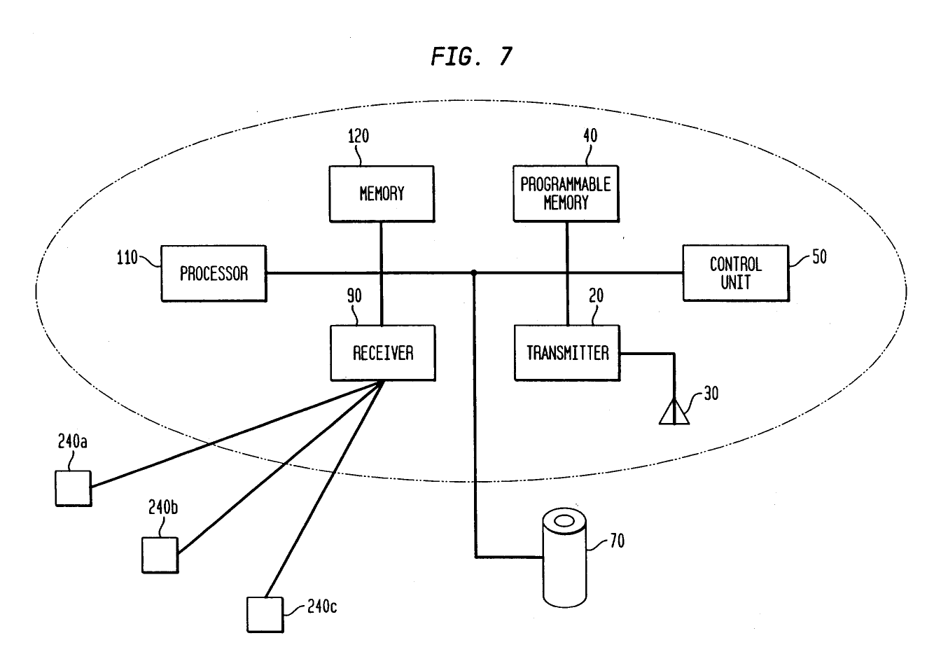

In another preferred embodiment, the communications unit includes a sensor or plurality of sensors for monitoring one or more parameters of the product, including, for example, wear of product parts and product performance. Referring to FIG. 7, sensors (240 a, b and c) monitor parameters x, y and z. The sensors output signals using, for example, a low power transmitter or a wire connection, to a receiver 90 connected to processor 120. Processor 120 generates “codes” relating to the use and operation of the product based on the signal received from the sensor or sensors The “codes” represent symptoms of the product, such as performance problems associated with the product or wear detected in a component of the product The codes are then transmitted to the registration service along with the product or purchase identifying information, as previously described. The registration service may, for example, contact the consumer to inform the consumer about the problems defined by the codes and/or use the codes in applying product warranties.

Sensors used to monitor the operation and use of the product in accordance with the present invention include, for example, sensors for determining pressure, temperature, electrical parameters, power supply, physical wear (such as wire wear or wear on optical components).

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

We claim:

1. A communications unit for registering a product with a registration service, said communications unit comprising:
means for affixing said communications unit to said product; and
a programmable memory unit for storing identifying information for transmission to said registration service;
a transmitter for transmitting a signal containing said identifying information to said registration service over a communications network; and
a control unit for automatically directing the transmission of said identifying information from said memory unit to said transmitter and from said transmitter to said registration service, thereby informing the registration service of the information needed to register said product.

2. The communications unit of claim 1 wherein said product has a serial number unique to said product and said identifying information comprises said serial number.

3. The communications unit of claim 1 wherein said product has a model number and said identifying information comprises said model number.

4. The communications unit of claim 1 wherein said product has a brand name and said identifying information comprises said brand name.

5. The communications unit of claim 1 wherein said communications unit comprises means for enabling said registration service to log the date and time of the transmission of said information.

6. The communications unit of claim 1 wherein said communications network is a wireless communications network.

7. The communications unit of claim 6 wherein said communications unit further includes an antenna connected to said transmitter.

8. The communications unit of claim 6 wherein said communications network is a network of ground stations equipped with transmitters and antennas for transmitting said information from said communications unit to said registration service.

9. The communications unit of claim 6 wherein said communications network is a network of orbiting satellites equipped with transmitters and antennas for transmitting said information from said communications unit to said registration service.

10. The communications unit of claim 1 wherein said communications network is the Internet and said transmitter comprises a modem.

11. The communications unit of claim 1 wherein said communications unit further includes a receiver for receiving information from an external source and a memory unit for storing said information received by said receiver from said external source.

12. The communications unit of claim 1 wherein said product is an A/V component connected to a network of A/V components.

13. The communications unit of claim 12 further including a connection to a BUS of said network of A/V components.

14. The communications unit of claim 11 wherein said external source is a remote access device used to input information for transmission to said registration service.

15. The communications unit of claim 11 wherein said control unit includes a processing unit for processing said information received from said external source.

16. The communications unit of claim 14 further including a user access interface for viewing said information received from said external source.

17. The communications unit of claim 16 wherein said user access interface is a liquid-crystal display.

18. The communications unit of claim 16 wherein said user access interface is a television monitor.

19. The communications unit of claim 11 wherein said external source is said registration service.

20. The communications unit of claim 11 wherein said external source is at least one sensor for detecting information relating to said operation or use of said product.

21. The communications unit of claim 20 further comprising a receiver in communication with said at least one sensor and a memory unit for storing said information relating to said operation or use of said product.

22. A communications unit for polling a product to determine the status of the product, comprising:
means for affixing said communications unit to said product; and
a receiver for receiving a signal from a registration service over a communications network;
a transmitter for transmitting a signal to said registration service over said communications network; and
a control unit for automatically directing the transmission of said signal to said registration service, thereby informing the registration service of the status of said product.

23. A system for registering a product with a registration service, said system comprising:
a registration service which is accessible from a communications network; and
a product having a communications unit; said communications unit comprising a programmable memory unit for storing identifying information for transmission to said registration service;
a transmitter for transmitting a signal containing said identifying information to said registration service over said communications network; and
a control unit for automatically directing the transmission of said identifying information from said memory unit to said transmitter and from said transmitter to said registration service; thereby informing the registration service of the information needed to register said product.
